(19) United States
(12) Patent Application Publication
(10) Pub. No.: US 2009/0205024 A1
(43) Pub. Date: Aug. 13, 2009

(54) SYSTEM AND METHOD FOR DYNAMIC LAYER 2 WHOLESALE

(75) Inventors: Mathias Kokot, West Medford, MA (US); Sanjay Wadhwa, Acton, MA (US); Brian M. Sullivan, Lexington, MA (US)

Correspondence Address: AKIN GUMP STRAUSS HAUER & FELD LLP, P.O.BOX 688, DALLAS, TX, 75313-0688, US

(73) Assignee: JUNIPER NETWORKS, INC., Sunnyvale, CA (US)

(21) Appl. No.: 12/030,056

(22) Filed: Feb. 12, 2008

(51) Int. Cl. H04L 9/32; H04J 15/00

(52) U.S. Cl. 726/5; 370/464; 726/2

(57) ABSTRACT

Methods and systems consistent with the present invention provide a dynamic mechanism to support wholesale access for broadband subscribers. This mechanism involves dynamically discovering a retail ISP for a subscriber, and dynamically cross-connecting a subscriber's connection to a logical connection corresponding to a retail ISP, and is equally applicable to static, PPP and DHCP-based subscribers. Furthermore, dynamic steering of subscribers can be performed at layer 2 or layer 3 of the OSI model.

### FIELD OF THE INVENTION

The present invention generally relates to aggregation, and relates more particularly to dynamic aggregation for a plurality of protocols.

### BACKGROUND

Broadband access technologies such as digital subscriber lines (DSL) enable internet service providers (ISPs) to provide internet services to subscribers over data networks. Rather than deploying their own data networks, ISPs typically lease access to data networks from network access providers (NAPs). A NAP might be, for example, a company that owns fiber optic cables used in data transmission. Thus, there are multiple ISPs providing internet services over one NAP's network, called an intervening network, to thousand of subscribers. As such, it is typically necessary to track which ISP a subscriber subscribes to, or in other words, which ISP “owns” the subscriber.

FIG. 1. illustrates a typical network topology where multiple ISPs (ISP A 117 and ISP B 118) serve multiple subscribers over a single aggregation network. A subscriber uses subscriber workstation 111 to send a request for internet services from their ISP, for example, ISP A 117. This request is transmitted via DSL modem 113 to an aggregation point called a DSL Access Multiplexer (DLSAM) 103. These devices are used to aggregate multiple DSL lines, and are often located remotely from the access point such as in neighborhoods and around office buildings. The DSLAMs are connected at layer 2 of OSI, to a network element referred to here as an “aggregator” 105. The aggregator aggregates connections from multiple DSLAMs, and potentially differentiates subscribers, authorizes and authenticates subscriber's access to the network, and either terminates the subscribers to provide services, or forwards the subscribers to a remote ISP that “owns” the subscriber. This forwarding is conventionally done in two ways.

The first method to steer subscriber requests to the appropriate ISP is to provide a static mapping of subscribers' connection to the owning ISP. When traffic is received on a connection corresponding to the subscriber, the aggregator finds the ISP mapping corresponding to the subscriber's connection, and tunnels the subscriber traffic through the intervening network to this ISP. This static mapping is provided in the aggregator 105 itself, and thus is difficult to change or update. If a subscriber switches its ISP, the access provider has to manually reconfigure the mapping of subscriber's connection to the ISP on the relevant aggregator. This is operationally complex.

A second method is described with respect to FIG. 1. In this method, when the subscriber first comes up, the aggregator 105 communicates with a Remote Authentication Dial-In User Service (RADIUS) server 223 to dynamically discover which ISP owns the subscriber. The RADIUS server 223 maintains a centralized repository of subscriber information including information about the ISP that owns the subscriber. The RADIUS server 223 returns the correct ISP information to the aggregator 105, and the aggregator tunnels a connection for the subscriber through the intervening network 101 to the correct ISP. The RADIUS server 223 can provide dynamic mapping of subscribers to ISPs, which is better than a static mapping. This removes the burden on the access provider to manually configure each aggregator with this mapping.

Tunneling is the transmission of data intended for use within a private network through the intervening network 101 in such a way that the routing nodes in the intervening network are unaware that the transmission is part of a private network. Tunneling is generally done by encapsulating the private network data and protocol information within the intervening network transmission units so that the private network protocol information appears to the intervening network 101 as data. While layer2 tunneling protocol (L2TP) provides a well-defined mechanism to tunnel a subscriber's point-to-point (PPP) sessions to the ISP, for static or Dynamic Host Configuration Protocol (DHCP)-based subscribers there is no specific tunneling mechanism to steer connections to an ISP.

### SUMMARY

Systems and methods consistent with the present invention provide a more efficient aggregation network. In the aggregation network, subscribers are dynamically, rather than statically, mapped to an ISP to which they subscribe. That is, the logical connection to the ISP is determined at the time a subscriber request is received. Accordingly, a mapping of subscriber identities to ISP connection points is easily updated for use with dynamic protocols such as DHCP. For example, a RADIUS server is coupled to an aggregator at the aggregation point to provide the dynamic mapping more efficiently. Furthermore, systems and methods consistent with the present invention are equally applicable to static, PPP and DHCP-based subscribers. Unlike conventional aggregation schemes, embodiments presented here are not limited to PPP aggregation.

Systems and methods consistent with the present invention provide a method in a data processing device for dynamically aggregating DSL connections at an aggregator connected to an intervening network and an authentication unit. The aggregator performs a method comprising the steps of receiving a subscriber message from a subscriber, querying the authentication unit to dynamically discover an ISP to which the subscriber subscribes and creating a logical connection through the intervening network between the subscriber and the ISP. The method may further include the steps of receiving a second subscriber message from a second subscriber, querying the authentication unit to dynamically discover a second ISP to which the second subscriber subscribes, and creating a second logical connection through the intervening network between the second subscriber and the second ISP. Receiving a first subscriber message may include receiving a DHCP request message. Receiving a DHCP request message may include receiving DHCP Option 82 information. The method may further include sending the DCHP Option 82 information to the authentication unit.

The authentication unit may be a RADIUS server that can be dynamically updated. Querying the authentication unit to dynamically discover the ISP to which the subscriber subscribes may include sending subscriber information to the RADIUS server, and receiving logical connection information for the ISP from the RADIUS server. Sending subscriber information may include sending one of a port, slot, and Customer Virtual Local Area Network Identifier (C-VLAN) of the subscriber to the RADIUS server. Sending subscriber information may further include sending subscriber credentials to the RADIUS server. Creating a logical connection between the first subscriber and the first ISP may include dynamically cross-connecting a C-VLAN of the first subscriber to a VLAN of the first ISP. Creating a logical connection between the first subscriber and the first ISP may also include dynamically cross-connecting a C-VLAN of the first subscriber to a Multi Protocol Label Switching (MPLS) Pseudo-Wire (PW) of the first ISP. Creating a logical connection between the first subscriber and the first ISP may still also dynamically cross-connecting a C-VLAN of the first subscriber to a Virtual Private LAN Segment (VPLS) of the first ISP.

Another embodiment consistent with systems and methods consistent with the present invention is directed to a computer-readable medium storing computer executable instructions for performing a method of matching a subscriber to an ISP owning the subscriber in a broadband network consisting of DSLAMs and aggregators. The method comprises the steps of receiving subscriber information from the aggregator, dynamically matching the subscriber to the ISP that owns the subscriber, and returning a logical connection to the ISP that owns the subscriber to the aggregator. Receiving subscriber information may include receiving DHCP Option 82 information. Receiving subscriber information may also include receiving one of a slot, port, and C-VLAN of the subscriber. The method may further comprise receiving subscriber credentials. Returning a logical connection may include returning a VLAN, MPLS PW, or VPLS of the ISP.

Yet another embodiment consistent with systems and methods consistent with the present invention are directed to a network processing device for dynamically aggregating DSL connections from a plurality of DSLAMs and directing a subscriber request to at least one ISP over an intervening network. The device comprises a RADIUS server that receives subscriber information and matches the subscriber to an ISP that owns the subscriber, and an aggregator that receives messages from a subscriber, queries the RADIUS server using the information about the subscriber, and directs data from the subscriber to the ISP that owns the subscriber using a logical connection to the ISP discovered from the RADIUS server.

Other systems, methods, features, and advantages consistent with the present invention will become apparent to one with skill in the art upon examination of the following figures and detailed description. It is intended that such additional systems, methods, features, and advantages be included within this description and be within the scope of the invention.

### BRIEF DESCRIPTION OF THE DRAWINGS

The accompanying drawings, which are incorporated in and constitute a part of this specification, illustrate an implementation of methods and systems consistent with the present invention and, together with the description, serve to explain advantages and principles consistent with the invention. In the drawings,

FIG. 1 illustrates a conventional aggregation network;

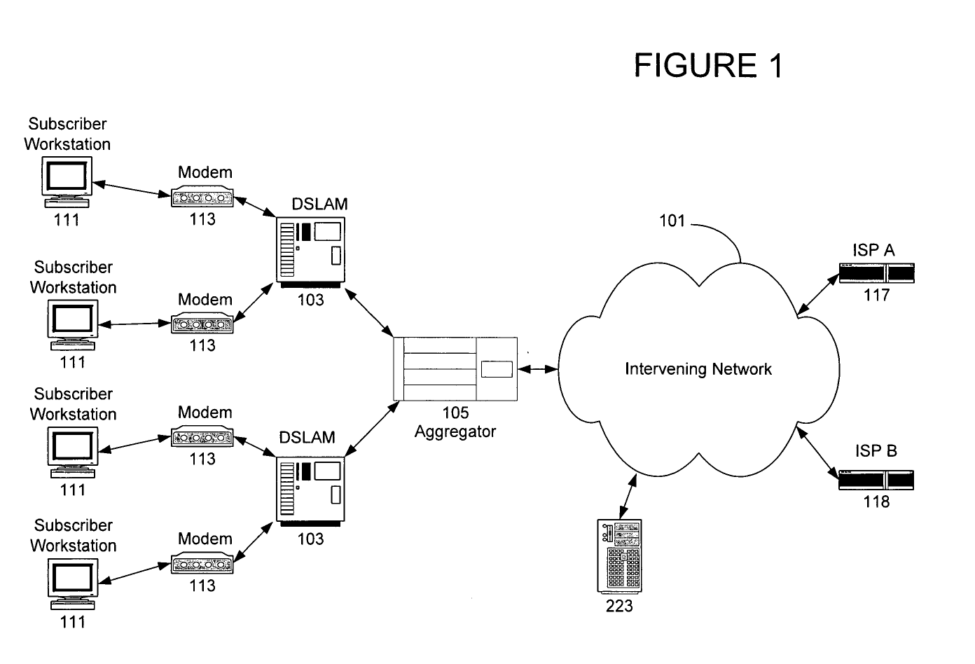

FIG. 2 illustrates aggregation network consistent with systems and methods consistent with the present invention;

FIG. 3 illustrates a method of dynamic aggregation consistent with systems and methods consistent with the present invention;

FIG. 4 illustrates a second aggregation network consistent with systems and methods consistent with the present invention; and

FIG. 5 illustrates an exemplary computer system suitable for use with systems and methods consistent with the present invention.

### DETAILED DESCRIPTION

Systems and methods consistent with the present invention achieve dynamic subscriber-to-ISP mapping. For example, systems and methods consistent with the present invention steer broadband subscriber connections towards the IP access device corresponding to the retail ISP or content provider (CP) owning the subscriber dynamically via a layer 2 or layer 3 intervening network. The ISP owning the subscriber is discovered based on interaction with a RADIUS policy server connected to an aggregator. Furthermore, this mechanism is agnostic to the subscriber's session management mechanism. That is, this scheme is generally applicable to static, PPP and DHCP subscribers. This dynamic steering of subscriber connection towards the retail ISP that owns the subscriber is referred to as “dynamic layer 2 (or 3) wholesale.”

Reference will now be made in detail to an implementation consistent with the present invention as illustrated in the accompanying drawings.

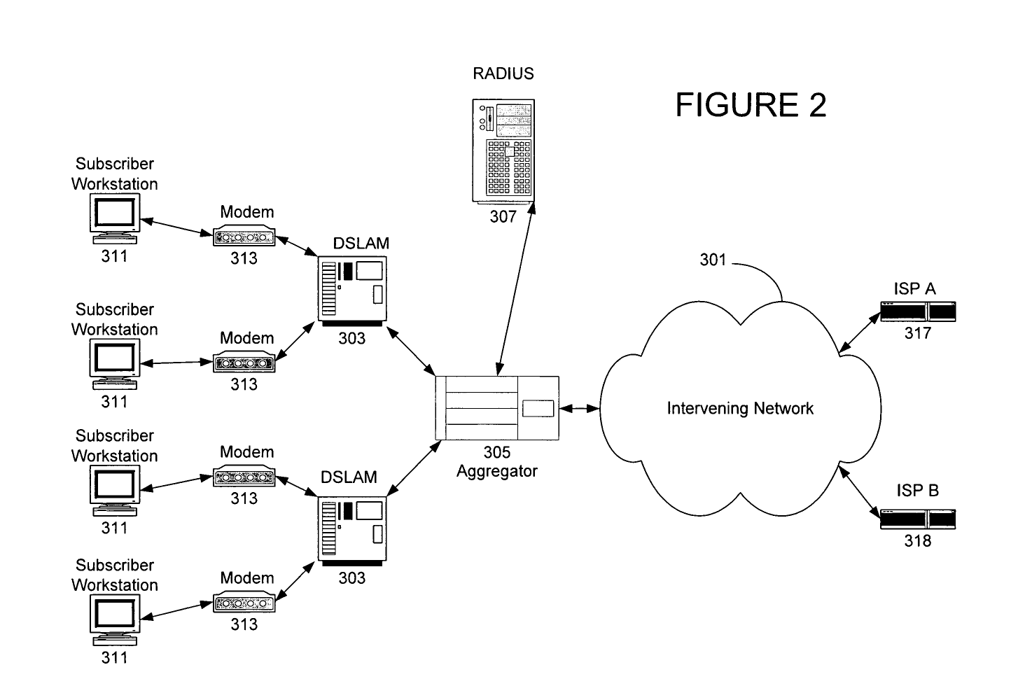

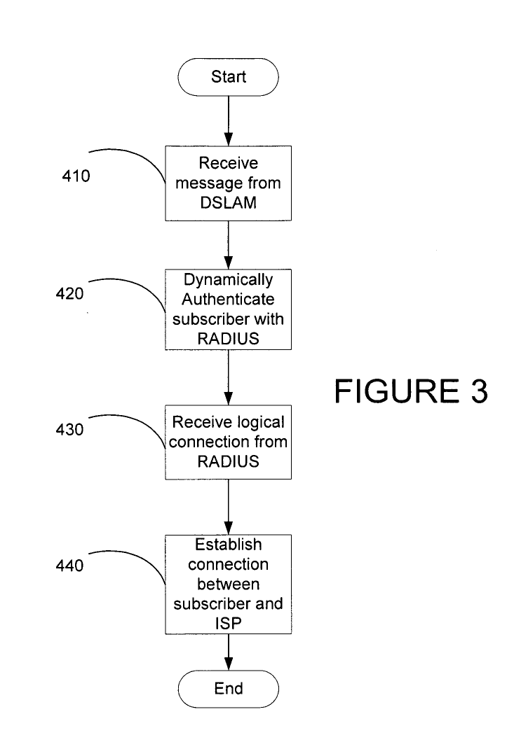

FIG. 2 illustrates an aggregation network consistent with systems and methods consistent with the present invention. A subscriber workstation 311 is connected to a DSL modem 313 via Ethernet, Universal Serial Bus (USB), or any other suitable interface. Modem 313 transmits and receives the user traffic over the DSL. Typically, subscriber workstation 311 is a personal computer (PC). A DSL Access Multiplexer (DSLAM) 103 terminates the DSL lines and multiplexes user traffic over a network uplink. Suitable protocols for uplink technologies include, but are not limited to: ATM, Ethernet 100M, or GbE. Aggregator 305 connects DSLAMs 303 to an ISP, e.g., ISP A 317 or ISP B 318, via the intervening network 301. The aggregator 305 may perform aggregation at layer 2 or layer 3 in the OSI model. The intervening network 301 is a transport network with which an NAS leases network transport services to ISPs. For example, in FIG. 3 the intervening network 301 connects subscriber workstations 311 to an ISP such as ISP A 317 or ISP B 318. When a request reaches the aggregator 305 via a DSLAM 303, the aggregator 305 communicates with RADIUS server 307 to match the subscriber initiating the request to the ISP that owns the subscriber. The RADIUS server 307 returns a logical connection to the appropriate ISP, such as the address of a router or server of the ISP, and the aggregator 305 initiates a connection to the ISP.

FIG. 3 illustrates a flow chart depicting a method of dynamically mapping a subscriber to a logical connection of a corresponding retail ISP that is consistent with the present invention. Multiple subscriber connections owned by a given ISP can be aggregated and cross-connected to a single connection per retail ISP. The dynamic mapping of the aggregator 305 is established by interaction with the RADIUS server 307. The process initiates when the aggregator 305 receives a message from a subscriber through DSLAM 303 (step 410). For example, the message may be a Dynamic Host Configuration Protocol (DHCP) request message. The aggregator 305 then authenticates the subscriber with the RADIUS server 307 to determine which ISP owns the subscriber (step 420). As part of authenticating the subscriber, the subscriber's local loop information (e.g., slot, port, or Customer Virtual Local Area Network (C-VLAN)) or DHCP option 82 are provided to the RADIUS server 307 by the aggregator 305. Optionally, subscriber credentials, including user-name, or domain name (in case of PPP) are also supplied to the RADIUS server 307. The RADIUS server 307 then responds with a logical connection or a layer 2 (L2) domain associated with the ISP owning the subscriber (step 430). The aggregator 305 then associates (cross-connects or bridges) the subscriber's logical connection connection/domain of the ISP, which was returned by the RADIUS server 307 (step 440).

If the intervening network has a pure layer 2 control plane, the subscriber connection is cross-connected to a VLAN corresponding to the ISP. The RADIUS server 307 provides a slot/port/VLAN corresponding to the retail ISP, and the aggregator 305 dynamically cross-connects the subscriber's C-VLAN to this RADIUS-returned VLAN. The subscriber's VLAN (C-VLAN) may also be tunneled inside a RADIUS-returned VLAN corresponding to the retail ISP. In this case, the VLAN stack would terminate on the ISP's access device.

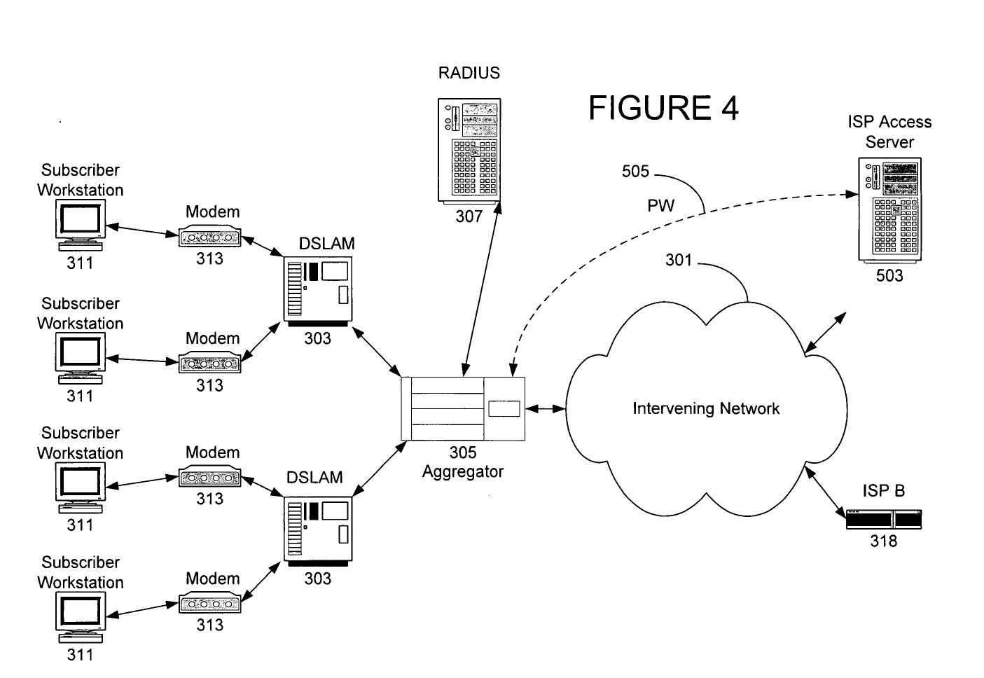

FIG. 4 illustrates an intervening network similar to that of FIG. 3, but where the network is Multi-Protocol Label Switching (MPLS) enabled. Like numerals are used to identify like components from FIG. 3. In the case where the intervening network 301 is MPLS enabled, there is MPLS p2p Ethernet pseudo-wire (PW) 305 to the retail ISP access server 303. Any subscriber owned by an ISP will be cross-connected to this pseudo-wire. This MPLS PW to the retail ISP access server 303 is per-subscriber or, more appropriately, per-L2-aggregator. In the latter case, the L2 aggregator tunnels the subscriber's VLAN in an ISP-specific VLAN provided by the RADIUS server 307. The resulting VLAN stack is then cross-connected to the RADIUS-returned MPLS PW terminating on ISP's access server 303.

In another embodiment consistent with the present invention, the MPLS control plane is a Virtual Private LAN Segment (VPLS) instance (or bridged domain) per retail ISP. The RADIUS server 307 returns a name for a VPLS instance corresponding to the retail ISP. Subscriber connections for subscribers owned by the ISP are bridged in this VPLS instance by the aggregator 305.

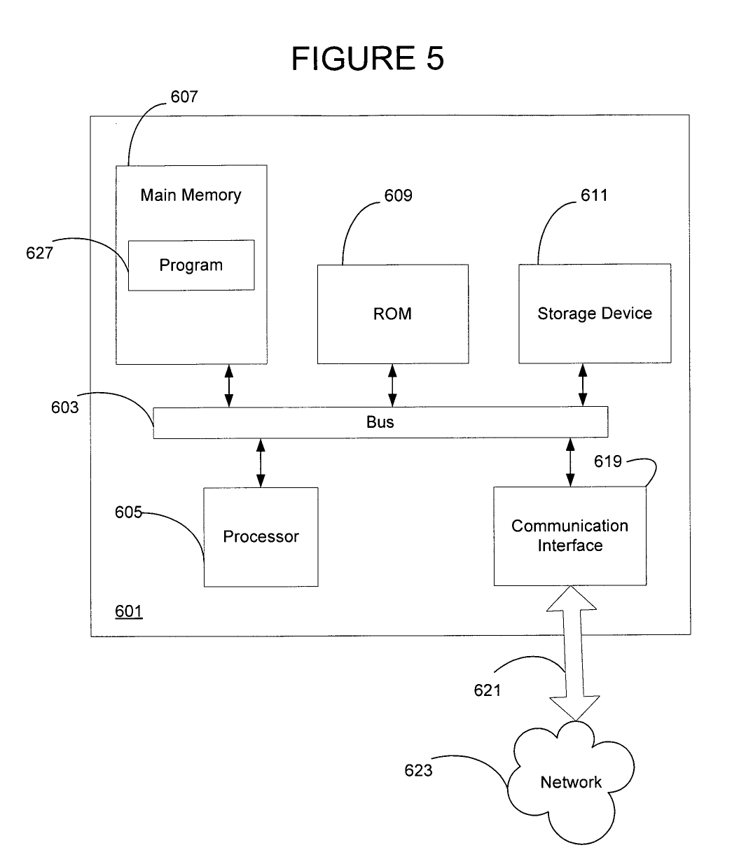

Turning to FIG. 5, an exemplary data processing system that can be configured as a network device consistent with the present invention is now described. Data processing system 601 includes a bus 603 or other communication mechanism for communicating information, and a processor 605 coupled with bus 603 for processing the information. Data processing system 601 also includes a main memory 607, such as a random access memory (RAM) or other dynamic storage device, coupled to bus 603 for storing information and instructions to be executed by processor 605. In addition, main memory 607 may be used for storing temporary variables or other intermediate information during execution of instructions to be executed by processor 605. Main memory 607 includes a program 627 for implementing dynamic aggregation methods consistent with the invention and described below. Data processing system 601 further includes a read only memory (ROM) 609 or other static storage device coupled to bus 603 for storing static information and instructions for processor 605. A storage device 611, such as a magnetic disk or optical disk, is provided and coupled to bus 603 for storing information and instructions.

According to one embodiment, processor 605 executes one or more sequences of one or more instructions contained in main memory 607. Such instructions may be read into main memory 607 from another computer-readable medium, such as storage device 611. Execution of the sequences of instructions in main memory 607 causes processor 605 to perform the process steps described herein. One or more processors in a multi-processing arrangement may also be employed to execute the sequences of instructions contained in main memory 607. In alternative embodiments, hard-wired circuitry may be used in place of or in combination with software instructions. Thus, embodiments are not limited to any specific combination of hardware circuitry and software.

Although described relative to main memory 607 and storage device 611, instructions and other aspects of methods and systems consistent with the present invention may reside on a computer-readable medium, such as a floppy disk, a flexible disk, hard disk, magnetic tape, a CD-ROM, magnetic, optical or physical medium, a RAM, a PROM, and EPROM, a FLASH-EPROM, any other memory chip or cartridge, or any other medium from which a computer can read, either now known or later discovered.

Data processing system 601 also includes a communication interface 619 coupled to bus 603. Communication interface 619 provides a two-way data communication coupling to a network link 621 that is connected to a local network 623. Wireless links may also be implemented. In any such implementation, communication interface 619 sends and receives signals that carry digital data streams representing various types of information.

While there has been illustrated and described embodiments consistent with the present invention, it will be understood by those skilled in the art that various changes and modifications may be made and equivalents may be substituted for elements thereof without departing from the true scope of the invention. Therefore, it is intended that this invention not be limited to any particular embodiment disclosed, but that the invention will include all embodiments falling within the scope of the appended claims.

We claim:

1. A method in a data processing system for dynamically aggregating digital subscriber line (DSL) connections at an aggregator connected to an intervening network and an authentication unit, the aggregator performing the method comprising the steps of:
receiving by the aggregator a subscriber message from a subscriber;
querying the authentication unit to dynamically discover an internet service provider (ISP) to which the subscriber subscribes; and
creating a logical connection through the intervening network between the subscriber and the ISP.

2. The method of claim 1, further comprising the steps of:
receiving a second subscriber message from a second subscriber;
querying the authentication unit to dynamically discover a second ISP to which the second subscriber subscribes; and
creating a second logical connection through the intervening network between the second subscriber and the second ISP.

3. The method of claim 1, wherein receiving a first subscriber message includes receiving a Dynamic Host Configuration Protocol (DHCP) request message.

4. The method of claim 3, wherein receiving a DHCP request message includes receiving DHCP Option 82 information.

5. The method claim 4, further comprising sending the DCHP Option 82 information to the authentication unit.

6. The method of claim 1, wherein the authentication unit is a RADIUS server that can be dynamically updated.

7. The method of claim 6, wherein querying the authentication unit to dynamically discover the ISP to which the subscriber subscribes includes:
sending subscriber information to the RADIUS server; and
receiving logical connection information for the ISP from the RADIUS server.

8. The method of claim 7, wherein sending subscriber information includes sending one of a port, slot, and Customer Virtual Local Area Network Identifier (C-VLAN) of the subscriber to the RADIUS server.

9. The method of claim 8, where sending subscriber information further includes sending subscriber credentials to the RADIUS server.

10. The method of claim 1, wherein creating a logical connection between the first subscriber and the first ISP includes dynamically cross-connecting a C-VLAN of the first subscriber to a VLAN of the first ISP.

11. The method of claim 1, wherein creating a logical connection between the first subscriber and the first ISP includes dynamically cross-connecting a C-VLAN of the first subscriber to a Multi Protocol Label Switching (MPLS) Pseudo-Wire (PW) of the first ISP.

12. The method of claim 1, wherein creating a logical connection between the first subscriber and the first ISP includes dynamically cross-connecting a C-VLAN of the first subscriber to a Virtual Private LAN Segment (VPLS) of the first ISP.

13. A computer-readable medium storing computer executable instructions for performing a method of matching a subscriber to an ISP owning the subscriber in an intervening network having an aggregator, the method comprising the steps of:
receiving subscriber information from the aggregator;
dynamically matching the subscriber to the ISP that owns the subscriber; and
returning a logical connection to the ISP that owns the subscriber to the aggregator.

14. The method of claim 13, wherein receiving subscriber information includes receiving DHCP Option 82 information.

15. The method of claim 13, wherein receiving subscriber information include receiving one of a slot, port, and C-VLAN of the subscriber.

16. The method of claim 15, further comprising receiving subscriber credentials.

17. The method of claim 13, wherein returning a logical connection includes returning a VLAN of the ISP.

18. The method of claim 13, wherein returning a logical connection includes returning a MPLS PW of the ISP.

19. The method of claim 13, wherein returning a logical connection includes returning a VPLS of the ISP.

20. A network processing device for dynamically aggregating digital subscriber line (DSL) connections from a plurality of DSL Access Multiplexers (DSLAMs) and directing a request from subscribers to Internet Service Providers (ISPs) over an intervening network, wherein each subscriber has an associated ISP, comprising:
a RADIUS server that receives information regarding the subscribers and matches the subscribers to the ISP associated with each of the subscribers; and
an aggregator that receives messages from the subscribers, queries the RADIUS server using the information about the subscribers, and directs data from the subscribers to the ISPs associated with each subscriber using a logical connection to the ISP discovered from the RADIUS server.
